(19) United States
(12) Patent Application Publication
(10) Pub. No.: US 2003/0058233 A1
(43) Pub. Date: Mar. 27, 2003

(54) Method and apparatus for reducing output variation by sharing analog circuit characteristics

(76) Inventors: Sung Tae Ahn, Seoul (KR); Yung Jin Jeon, Seoul (KR); Chen Young Jeong, Seoul (KR); Keunmyung Lee, Palo Alto, CA (US)

Correspondence Address: Chung K. Ko, Suite 236, 3003 N. First St., San Jose, CA, 95134, US

(21) Appl. No.: 10/232,593

(22) Filed: Aug. 30, 2002

Related U.S. Application Data
(60) Provisional application No. 60/325,258, filed on Sep. 26, 2001.

(51) Int. Cl. G09G 5/00

(52) U.S. Cl. 345/211

(57) ABSTRACT

A scheme to reduce output variations in a column driver for a flat-panel display by sharing the characteristics of analog circuit is disclosed. An input multiplexer is provided between two neighboring digital inputs, and an output multiplexer is provided between two neighboring analog outputs so that the characteristics of neighboring analog circuits can be shared by multiplexing. The averaging effect by sharing reduces variations in the output. The multiplexing may be done either in time division or on a frame-by-frame basis.

### RELATED APPLICATION

This application claims the benefit of co-pending U.S. Provisional Application Ser. No. 60/325,258, filed Sep. 26, 2001, entitled “Method and Apparatus for Reducing Output Variation by Sharing Analog Circuit Characteristics.”

### BACKGROUND OF THE INVENTION

1. Technical Field

This invention in general relates to semiconductor circuits. More specifically, this invention relates to circuits for sharing analog circuit characteristics in flat-panel displays to compensate for variations in the outputs.

2. Description of the Related Art

FIG. 1 shows a conventional driver circuit for a flat panel display in general. Each digital input is converted to an analog value by a digital-to-analog (D/A) converter and buffered before an output is generated. For example, Data 1 of n-bits is converted by D/A1 to an analog value, which is then buffered to produce Out1.

Ideally, one digital input should produce the same analog output in different columns. In practice, however, for the same digital input, there are column-to-column deviations in the output because there are variations in the analog characteristics of the D/A converters and buffers due to many reasons such as processing variations.

Therefore, there is a need for a scheme to compensate for the output deviations due to variations in the analog circuit characteristics.

### SUMMARY OF THE INVENTION

It is an object of the present invention to compensate for any output deviations due to variations in the analog circuit characteristics.

The foregoing and other objects are accomplished by sharing the characteristics of multiple neighboring analog circuits. Provided for each column are an input multiplexer for multiplexing neighboring digital inputs into one and an output multiplexer for multiplexing neighboring analog outputs into one. Sharing the characteristics of the neighboring analog circuits through multiplexing may be done in time division. Alternatively, sharing the characteristics of the neighboring analog circuits may be done on a frame basis. For example, at every n frames, different analog circuits may be selected for driving the outputs.

### BRIEF DESCRIPTION OF THE DRAWINGS

FIG. 1 is a schematic of a prior art output driver.

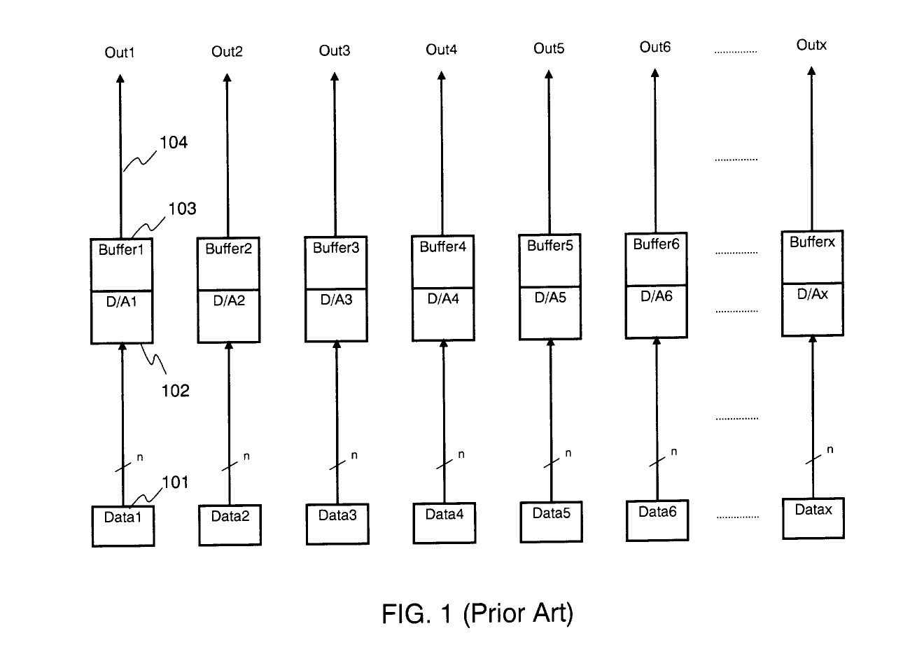

FIG. 2 is a schematic of an output driver of the present invention using multiplexing.

FIG. 3 is an illustration of an averaging effect by sharing the characteristics of neighboring analog circuits.

### DETAILED DESCRIPTION OF THE INVENTION

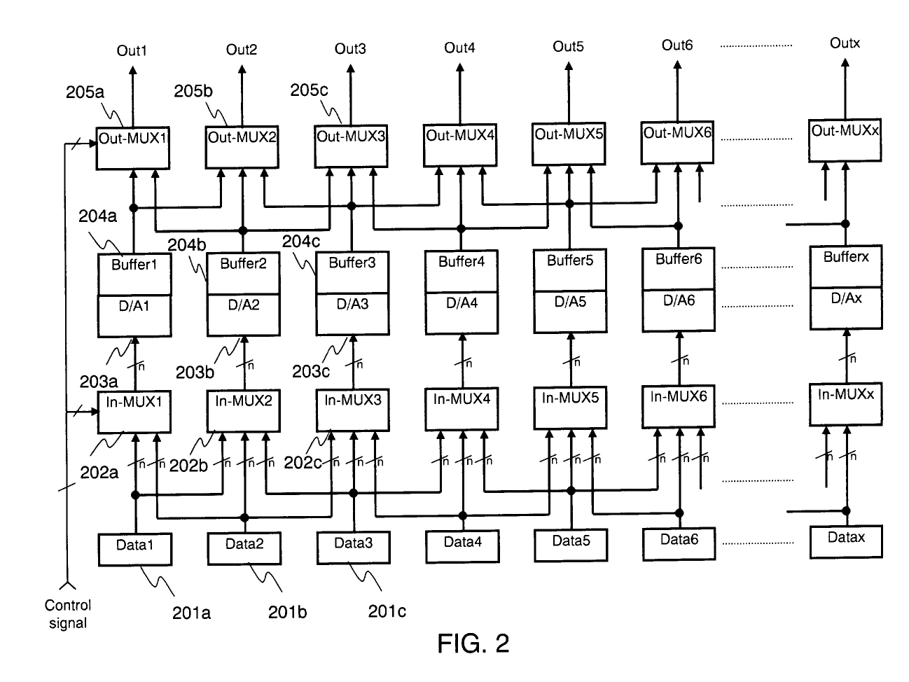

FIG. 2 shows a scheme of the present invention for reducing output variation. Provided for each column are an input multiplexer (In-MUX) for selecting among inputs from multiple neighboring digital inputs and an output multiplexer (Out-MUX) selecting one among outputs from multiple neighboring analog outputs. For example, In-MUX2 is provided to select one among three inputs, Data1, Data2, and Data3. Similarly, Out-MUX2 is provided to select one among three outputs Buffer1, Buffer2, and Buffer3.

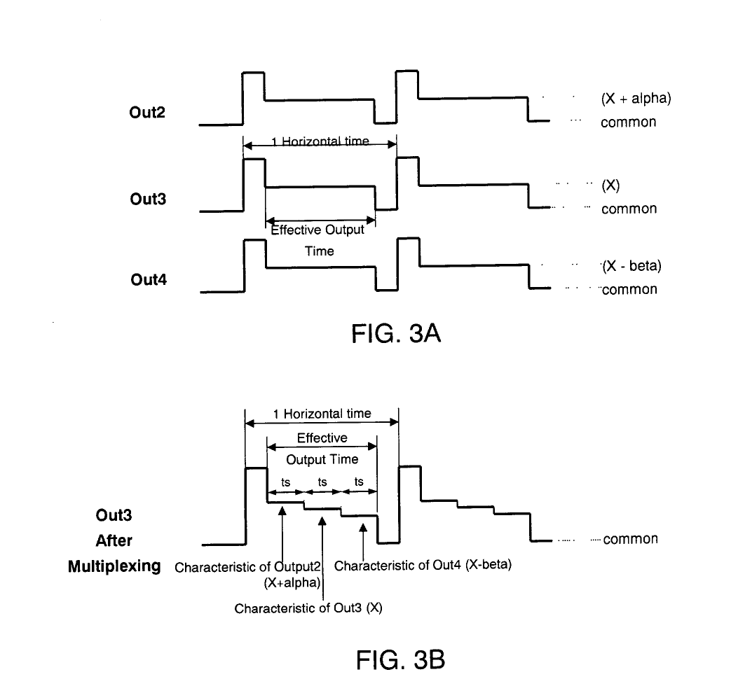

FIG. 3 illustrates an averaging effect obtained by sharing the characteristics of the analog circuits. The example shows the case where the effective output time is divided into three time slots, and a different analog circuit drives the output during each time slot. The averaging effect reduces the output variations to any variation in the analog device characteristics.

Sharing the characteristics of the analog circuits may be done on a frame-by-frame basis. For example, in every n frames, the multiplexers may switch the analog circuits driving the outputs.

While the invention has been described with reference to preferred embodiments, it is not intended to be limited to those embodiments. It will be appreciated by those of ordinary skilled in the art that many modifications can be made to the structure and form of the described embodiments without departing from the spirit and scope of this invention.

What is claimed is:

1. A driver circuit for converting digital inputs to analog outputs while reducing output deviations due to variations in analog circuit characteristics, comprising:
a plurality of input multiplexers (“input MUXs”), each input MUX receiving inputs from a plurality of digital inputs;
a plurality of digital-to-analog converters (“D/A”), each D/A connecting to one of the input multiplexers to receive input from the corresponding input MUX;
a plurality of buffers, each buffer connected to one of the D/A;
a plurality of output multiplexers (“output MUXs”) for producing analog outputs, each output MUX receiving inputs from a plurality of outputs from the buffers; and
a control circuit for controlling the input MUXs and output MUXs to select different D/As for driving the analog outputs whereby the analog outputs from the driver share neighboring analog characteristics of D/As used.

2. The driver circuit of claim 1, wherein different D/As are selected for driving the analog outputs during a different time slot in time division.

3. The driver circuit of claim 1, wherein different D/As are selected for driving the analog outputs at every n frames.

4. A method for converting digital inputs to analog output while reducing output deviations due to variations in analog circuit characteristics, comprising the steps of:
input-multiplexing among a plurality of digital inputs;
converting digital inputs to analog signals by using digital-to-analog converters (“D/A”);
buffering a plurality of buffers, each buffer connected to one of the D/A; and
output-multiplexing among the buffered outputs to produce analog outputs;
wherein input-multiplexing and output-multiplexing are controlled to select different D/As for driving the analog outputs whereby the outputs from the driver share neighboring analog characteristics of D/As used.

5. The method of claim 4, wherein different D/As are selected for driving the analog outputs during a different time slot in time division.

6. The method of claim 4, wherein different D/As are selected for driving the analog outputs at every n frames.
